(19) United States
(12) Patent Application Publication
(10) Pub. No.: US 2024/0152677 A1
(43) Pub. Date: May 9, 2024

(54) CIRCUIT STRUCTURE OPTIMIZATION METHOD AND SYSTEM BASED ON FPGA CARRY CHAIN

(71) Applicant: SHENZHEN PANGO MICROSYSTEMS CO., LTD., SHENZHEN (CN)

(72) Inventors: BO DENG, SHENZHEN (CN); BIAO KONG, SHENZHEN (CN); MIN ZHANG, SHENZHEN (CN)

(21) Appl. No.: 18/402,744

(22) Filed: Jan. 3, 2024

Related U.S. Application Data
(63) Continuation-in-part of application No. PCT/CN2022/106775, filed on Jul. 20, 2022.

(30) Foreign Application Priority Data
Jul. 20, 2021 (CN) 202110819418.5

(51) Int. Cl. G06F 30/343; G06F 30/327; G06F 30/3315; G06F 30/337; G06F 119/12

(52) U.S. Cl. CPC G06F 30/343; G06F 30/327; G06F 30/3315; G06F 30/337; G06F 2119/12

(57) ABSTRACT

Provided are a method for optimizing a circuit structure based on an FPGA carry chain, a computer device and a non-transitory computer-readable storage medium, in which logic synthesis is performed, by a logic synthesis tool, on a target logic operation, and a synthesis netlist is obtained through the logic synthesis; a critical path is obtained in the synthesis netlist; and in response to the number of actual inputs of a look-up table in the critical path being not greater than a preset threshold, and at least one of elements adjacent to two ends of a reference path in the critical path being a carry chain, the look-up table in the critical path is converted into a carry chain, where the reference path includes the look-up table, and only one look-up table or multiple adjacent look-up tables compose the reference path.

### CROSS-REFERENCE TO RELATED APPLICATIONS

This application is a continuation-in-part of International Application No. PCT/CN2022/106775, filed Jul. 20, 2022, which claims priority to Chinese patent application No. 202110819418.5, filed on Jul. 20, 2021, both of which are herein incorporated by reference in their entireties.

### TECHNICAL FIELD

The disclosure relates to the technical field of electronic circuits, and particularly to a method for optimizing a circuit structure based on an FPGA carry chain, a computer device, and a non-transitory computer-readable storage medium.

### BACKGROUND

With the development of digitalization and intelligence, field programmable gate array (FPGA) chip components have become indispensable core devices in fields of communication, aerospace, military industry, etc. The FPGA chip components are essential supportive foundations for ensuring national strategic security. A logic synthesis tool in an FPGA software maps a digital IC design into a gate-level netlist and optimizes its redundant circuit structure, and a resulting performance level thereof greatly affects a subsequent layout result and even directly affects critical performance of the final chip in usage, such as timing and power consumption.

During a synthesis process using a synthesizer of an FPGA chip, the synthesizer is required to reference one or more function libraries containing a target technology, in which the function library contains functions such as a multi-bit adder, a register, and a memory, due to characteristics and limitations of a hardware structure of the synthesizer. The synthesizer effectively synthesizes a design part into an actual gate-level netlist, by analyzing hardware description language and generating RTL description through a compiler. The synthesizer not only converts a high-level abstraction description into a low-level description, but also optimizes the logical structure of the design, e.g., by removing a redundant circuit structure or multiplexing circuit modules with the same function.

Generally speaking, a small look-up table (LUT) is used in the FPGA to implement a logic function. By storing a truth table, any logic function with n inputs and one output may be implemented, and the number of the inputs generally ranges from 4 to 6. One of critical operations of FPGA logic synthesis is to decompose a large logic block with multiple inputs into small logic functions each with 4 to 6 inputs, and it uses the LUT to implement such small logic functions.

However, a large time delay would be generated during the process of using the LUT to implement the logic function. Therefore, there is an urgent need for a method for optimizing a circuit structure based on an FPGA carry chain.

### SUMMARY

Embodiments of the disclosure provide a method for optimizing a circuit structure based on an FPGA carry chain, a computer device, and a non-transitory computer-readable storage medium.

In a first aspect, the embodiments of the disclosure provide the method for optimizing a circuit structure based on an FPGA carry chain. The method includes:
performing, by a logic synthesis tool, logic synthesis on a target logic operation, and obtaining, through the logic synthesis, a synthesis netlist;
obtaining a critical path in the synthesis netlist; and
in response to the number of actual inputs of a look-up table in the critical path being not greater than a preset threshold, and at least one of elements adjacent to two ends of a reference path in the critical path being a carry chain, converting the look-up table in the critical path into a carry chain, where the reference path includes the look-up table, and only one look-up table or a plurality of adjacent look-up tables compose the reference path.

In another aspect, the embodiments of the disclosure provide a computer device. The computer device includes a memory, a processor, and a computer program stored in the memory and executable by the processor. The processor is configured to execute the computer program to implement operations of a method for optimizing a circuit structure based on an FPGA carry chain. In some embodiments, the method includes: performing, by a logic synthesis tool, logic synthesis on a target logic operation, and obtaining, through the logic synthesis, a synthesis netlist; obtaining a critical path in the synthesis netlist; determining a reference path in the critical path, wherein the reference path is composed of only one look-up table or a plurality of adjacent look-up tables, and the number of actual inputs of each look-up table of the reference path is greater than a preset threshold; and in response to at least one of elements adjacent to two ends of the reference path being a carry chain, converting the look-up table in the reference path into a carry chain.

In yet another aspect, the embodiments of the disclosure provide a non-transitory computer-readable storage medium storing a computer program. The computer program, when being executed by the processor, causes operations of a method for optimizing a circuit structure based on an FPGA carry chain. In some embodiments, the method includes: performing, by a logic synthesis tool, logic synthesis on a target logic operation, and obtaining, through the logic synthesis, a synthesis netlist; obtaining a critical path in the synthesis netlist; determining a reference path in the critical path, the reference path being composed of one look-up table or a plurality of adjacent look-up tables; and in response to the number of actual inputs of each look-up table in the reference path being not greater than a preset threshold, and at least one of elements adjacent to two ends of the reference path being a carry chain, converting each look-up table in the reference path into a carry chain.

### BRIEF DESCRIPTION OF THE DRAWINGS

FIG. 1 is a flowchart of a method for optimizing a circuit structure based on an FPGA carry chain according to some embodiments of the disclosure.

FIG. 2 is a schematic diagram illustrating an application of logic synthesis according to some embodiments of the disclosure.

FIG. 3 is a schematic structural diagram illustrating a carry chain according to some embodiments of the disclosure.

FIG. 4 is a schematic diagram of a reference path according to some embodiments of the disclosure.

FIG. 5 is a schematic diagram of another reference path according to some embodiments of the disclosure.

FIG. 6 is a schematic diagram illustrating a basic structure of a carry chain according to some embodiments of the disclosure.

FIG. 7 is a schematic structural diagram illustrating sum logic in the carry chain according to some embodiments of the disclosure.

FIG. 8 is a schematic structural diagram illustrating a logic synthesis operation according to some embodiments of the disclosure.

FIG. 9 is a schematic diagram illustrating a circuit structure obtained after a conversion of a logic operation according to some embodiments of the disclosure.

FIG. 10 is a schematic structural diagram of a system for optimizing a circuit structure based on an FPGA carry chain according to some embodiments of the disclosure.

FIG. 11 is a schematic structural diagram of a computer device according to some embodiments of the disclosure.

The realization of the objects, the functional characteristics and the advantages of the disclosure will be further described in conjunction with the embodiments and with reference to the drawings.

### DETAILED DESCRIPTION OF PREFERRED EMBODIMENTS

It should be understood that the specific embodiments described herein are intended for explaining the disclosure, rather than being construed as a limitation on the disclosure.

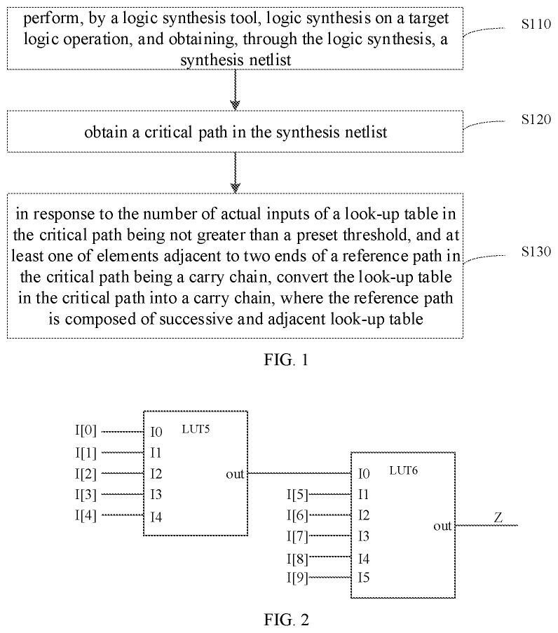

FIG. 1 is a flowchart of a method for optimizing a circuit structure based on an FPGA carry chain according to some embodiments of the disclosure. As illustrated in FIG. 1, the method includes operations as follows.

At S110, logic synthesis is performed, by using a logic synthesis tool, on a target logic operation, and a synthesis netlist is obtained through the logic synthesis.

The logic synthesis tool is generally adopted to perform the logic synthesis on the target logic algorithm. The logic synthesis tool generally refers to software that integrates various operating functions. The target logic algorithm generally refers to a logic operation. The logic synthesis refers to a process of converting, by using a tool, register transfer level (RTL) codes into a gate-level netlist. A common logic synthesis tool is Design Compiler of synopsys. A process of synthesizing one logic operation starts from reading the RTL codes, on which a timing constraint is imposed and then mapping is performed therefor to generate a file of the gate-level netlist, and the process may include three operations as follows.
1. Translation: a RTL description language of a circuit is read in, and the description language is translated into corresponding functional blocks and a topology between the functional blocks. This process results in a Boolean function expression for the circuit being generated in a synthesizer, without any logic reorganization or optimization.
2. Optimization: according to the imposed timing constraint and area constraint, logic reorganization and optimization are performed on the translation result, based on a specific algorithm.
3. Mapping: according to the imposed timing constraint and area constraint, a qualified unit is searched from a target technology library to form a logic synthesis netlist of the actual circuit. Such logic synthesis netlist is the synthesis netlist in the embodiments of the disclosure.

For example, in order to implement a design as follows, the target logic algorithm is an AND operation for a ten-bit input (which means an AND operation performed on inputs of ten bits), and in a synthesis result of the logic synthesis tool, two connected look-up tables are used to implement the logic function. FIG. 2 is a schematic diagram illustrating an application of the logic synthesis according to some embodiments of the disclosure.

The design is:

module and_test
(
input [9:0] I,
output Z
);
assign Z = &I;
endmodule

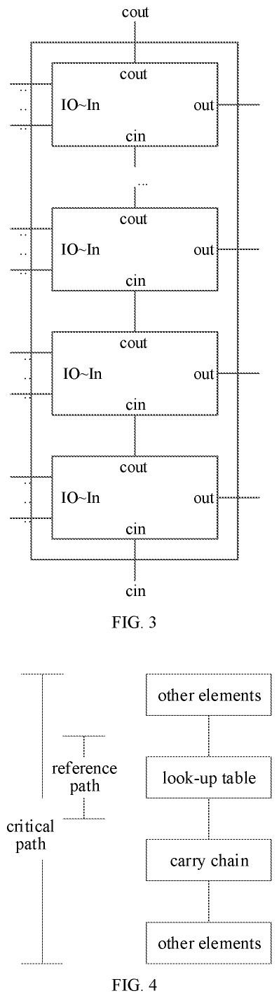

A basic hardware structure of the FPGA further includes a fast carry chain. FIG. 3 is a schematic structural diagram illustrating the carry chain structure according to some embodiments of the disclosure. As illustrated in FIG. 3, the carry chain structure generally adopts a structure of a ripple-carry adder, and the carry chain is used to execute arithmetic operations such as addition and subtraction for a large bit width. A basic structure of the carry chain in the basic hardware structure generally includes a dual-output look-up table (LUT) with 4 to 6 inputs, as well as other logic gates such as a selector.

At S120, a critical path in the synthesis netlist is obtained.

A static timing analysis tool is used to perform timing analysis on the generated synthesis netlist, and the critical path in the synthesis netlist is determined through the timing analysis.

In the embodiments of the disclosure, the critical path may be any path that has a great impact on the delay of the circuit.

At S130, in response to the number of actual inputs of a look-up table in the critical path being not greater than a preset threshold, and at least one of elements adjacent to two ends of a reference path in the critical path being a carry chain, the look-up table in the critical path is converted into a carry chain, in which the reference path is composed of successive and adjacent look-up tables.

When there are multiple critical paths, for each critical path, it is determined whether there is a look-up table in the critical path. When there is a look-up table in this critical path, the number of actual input signals for the look-up table is calculated. When the number of the actual input signals is not greater than the preset threshold, and at least one of elements, which are adjacent to two ends of the reference path where the look-up table is located, is the carry chain, it indicates that the look-up table meets a conversion requirement, and conversion may be performed on the look-up table.

In the embodiments of the disclosure, FIG. 4 is a schematic diagram of a reference path according to some embodiments of the disclosure. As illustrated in FIG. 4, the reference path may include only one look-up table. In a case where the reference path includes only one look-up table, when at least one of two elements each adjacent to the look-up table is the carry chain, it indicates that the look-up table meets the conversion requirement, and the conversion is performed on the look-up table.

In addition, FIG. 5 is another schematic diagram of the reference path according to some embodiments of the disclosure. As illustrated in FIG. 5, the reference path may also include a series of successive and adjacent look-up tables. In this case, when at least one of the elements adjacent to the two ends of the reference path is the carry chain, all look-up tables in the reference path are converted into carry chains. That is, each look-up table in the critical path is converted into a corresponding carry chain.

The embodiments of the disclosure provide the method for optimizing a circuit structure based on an FPGA carry chain, in which the look-up table in the critical path that meets the conversion requirement is searched out and it is converted into the carry chain. Since a delay between two elements, one being the carry chain and the other being the look-up table, is large, whereas a delay between two carry chains is small, the carry chain and the look-up table, which are adjacent to each other, are converted into two adjacent carry chains, thereby reducing the delay of the circuit, increasing the frequency of the circuit, and improving the performance of the FPGA chip. The method mainly aims to reduce a delay of a critical path of circuit timing, effectively improve an overall maximum frequency of a circuit, and enhance performance of a target FPGA chip.

Moreover, in the embodiments of the disclosure, a better effect of timing optimization can be achieved by converting only a small number of the look-up tables in the critical path, which has an extremely small load on a software runtime. In addition, it uses a small amount of carry chain resources but the FPGA chip is extremely rich in the carry chain resources, this would not have an impact on the resource use of the chip.

On the basis of the above embodiments, in some implementations, the preset threshold is determined based on a target FPGA chip which is configured to implement the target logic operation.

Specifically, the preset threshold is determined based on the target FPGA chip. Different types of chips have different numbers of pins and different usages. Therefore, different target FPGA chips correspond to different preset thresholds.

On the basis of the above embodiments, in some implementations, the preset threshold is the theoretical number of inputs of a look-up table in the carry chain of the target FPGA chip plus one.

Specifically, the preset threshold is the theoretical number of the inputs of the look-up table in the carry chain of the target FPGA chip plus one.

Specifically, the preset threshold is the theoretical number of the inputs of the LUT in the carry chain of the target FPGA chip plus the number of cin pins. For example, when the number of the cin pins is 1, the preset threshold is the theoretical number of the inputs of the look-up table in the carry chain of the target FPGA chip plus one.

The input pins of the carry chain of the target FPGA chip are adequate, only when the number of actual input pins of the look-up table in the reference path is not greater than the preset threshold.

On the basis of the above embodiments, in some implementations, there are one or more critical paths.

Specifically, in the embodiments of the disclosure, the number of the critical path may be one or multiple. Since the frequency of the circuit is determined based on the path having the worst delay, i.e., the path having the largest delay, an optimization for timing of the other paths does not work well on increasing the frequency of the circuit. Nonetheless, it is also possible to optimize the other paths.

When there is one critical path, the critical path is the path having the largest delay, that is, the path that plays a decisive role in timing performance of the design. When there are multiple critical paths, the critical paths certainly include the path having the largest delay. In other embodiments, the paths are ranked in descending order by delay, and multiple top ranking paths are taken as the multiple critical paths.

On the basis of the above embodiments, in some implementations, converting the look-up table in the critical path into the carry chain, includes:
replacing the look-up table in the critical path with the carry chain, in such a manner that an actual signal input pin of the look-up table in the critical path is replaced with an input pin of the carry chain, and an actual signal output pin of the look-up table in the critical path is replaced with an output pin of the carry chain.

Specifically, a logic function of the FPGA chip is generally implemented by programmable interconnect look-up tables, so that cascaded look-up tables usually appear in the critical path of the design. If the delay in this case can be reduced, the timing performance of the design can be optimized directly and effectively.

Since the carry chain generally adopts a clever signal topology and fast technology, and an internal transmission delay of the carry chain is extremely small, an overall delay of the circuit using the carry chain is much lower than a total delay of programmable interconnection of the conventional look-up tables in the FPGA chip.

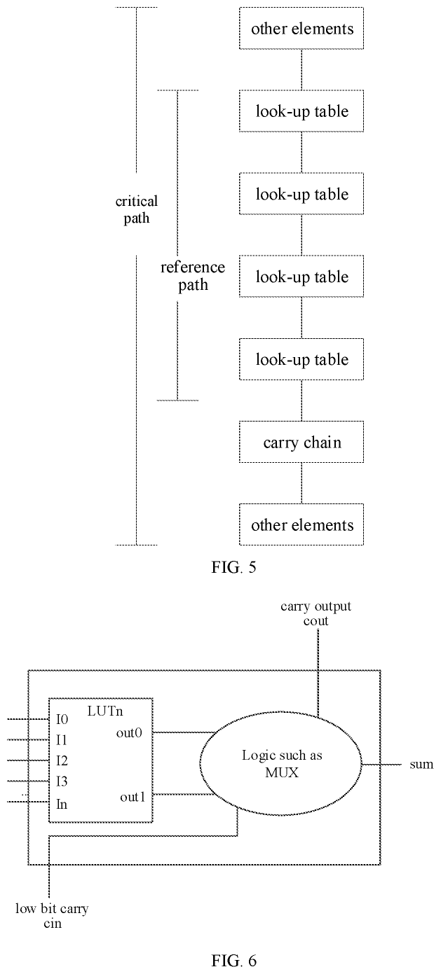

FIG. 6 is a schematic diagram illustrating a basic structure of a carry chain according to some embodiments of the disclosure. As illustrated in FIG. 6, compared with the ordinary LUT, in order to realize the functions of arithmetic operations with carry, such as addition and subtraction with carry, the CARRY (carry chain) includes not only a LUT with dual outputs but also a logic, such as a selector mux, to realize a sum operation and a carry operation for a carry output cout.

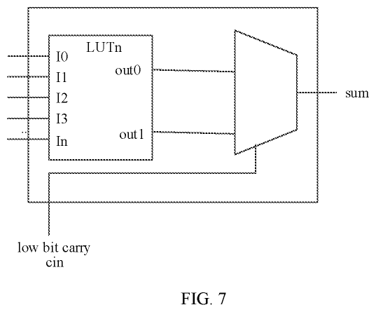

The sum operation of addition may be simplified to sum=A\hat{ }B\hat{ }CIN, where A represents an exclusive OR operation, and a logic function of A\hat{ }B may be implemented by a LUTn in the CARRY. FIG. 7 is a schematic structural diagram illustrating sum logic in the carry chain according to some embodiments of the disclosure. The structure as illustrated in FIG. 7 may realize a logic implementation for sum in the carry chain. The operation part of the sum logic in the figure is consistent with that of a LUT whose input is n+1 bits, and it can implement any logic function with n+1 inputs. Therefore, the operation part may replace the logic function of an ordinary LUT in the FPGA.

Therefore, as long as the number of the inputs of the LUT in the FPGA is less than or equal to the number of inputs of the LUT in the carry chain plus one, it is possible to replace the LUT with CARRY resource in the chip.

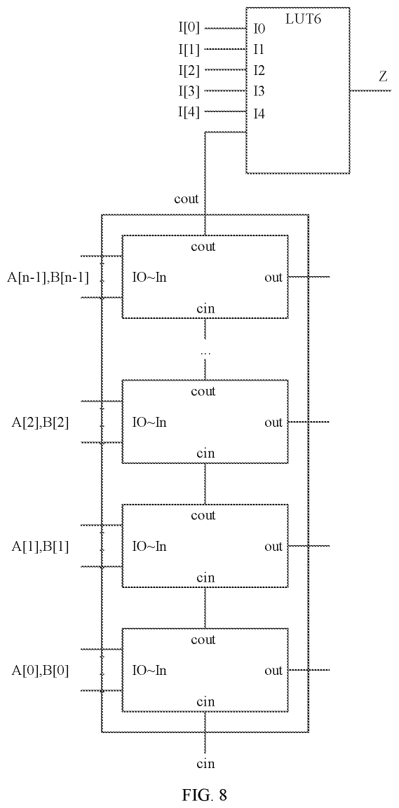

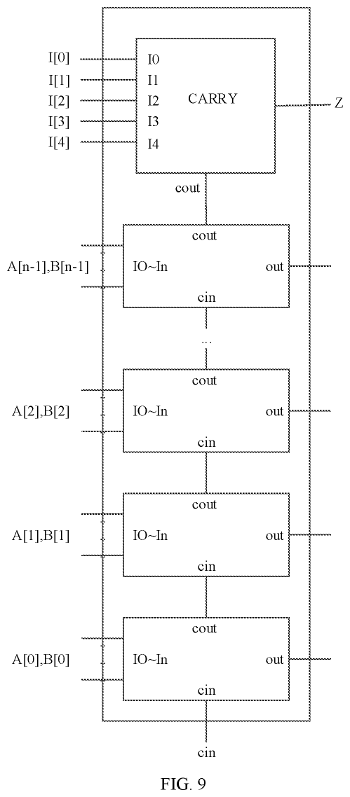

A result of the logic synthesis tool for calculating the target logic operation, such as Z=(A==B) ? (&I): 0 is generally illustrated in FIG. 8. FIG. 8 is a schematic structural diagram illustrating a logic synthesis operation according to some embodiments of the disclosure. The number of the actual inputs of the LUT6 is 6, the theoretical number of the inputs of the LUT6 in the CARRY is 5, so that the preset threshold is 5+1=6. The number of the actual inputs of the LUT6 is equal to the preset threshold, so that the LUT6 may be converted into a stage in its previous carry chain, and a sum of a delay of a connection line from the carry chain to the LUT 6 and a delay of the LUT6 itself is converted into a small delay of the carry chain. FIG. 9 is a schematic diagram illustrating a circuit structure obtained after a conversion of a logic operation according to some embodiments of the disclosure. As illustrated in FIG. 9, a purpose of reducing the delay of the circuit is achieved.

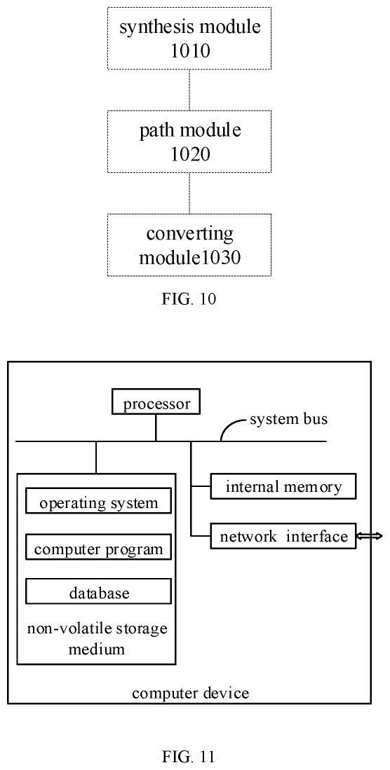

FIG. 10 is a schematic structural diagram of a system for optimizing a circuit structure based on an FPGA carry chain according to some embodiments of the disclosure. As illustrated in FIG. 10, the system includes a synthesis module 1010, a path module 1020 and a converting module 1030.

The synthesis module 1010 is configured to perform, by a logic synthesis tool, logic synthesis on a target logic operation, and obtain, through the logic synthesis, a synthesis netlist.

The path module 1020 is configured to obtain a critical path in the synthesis netlist.

The converting module 1030 is configured to, in response to the number of actual inputs of a look-up table in the critical path being not greater than a preset threshold, and at least one of elements adjacent to two ends of a reference path in the critical path being a carry chain, convert the look-up table in the critical path into a carry chain, where the reference path is composed of successive and adjacent look-up tables.

In some embodiments, the preset threshold is determined based on a target FPGA chip, and the target FPGA chip is configured to implement the target logic operation.

In some embodiments, the preset threshold is a theoretical number of inputs of a look-up table in the carry chain in the target FPGA chip plus the number of cin pins.

In some embodiments, the preset threshold is a theoretical number of inputs of the look-up table in the carry chain in the target FPGA chip plus one.

In some embodiments, there is one or more critical paths.

In some embodiments, there are multiple critical paths. The converting module 1030 is configured to: for each critical path, determine whether there is a look-up table in the critical path; calculate, in response to the look-up table being determined in the critical path, the number of actual input signals for the look-up table; and convert the look-up table in the critical path into the carry chain, in response to the number of the actual input signals being not greater than the preset threshold, and at least one of elements adjacent to two ends of a reference path where the look-up table is located being the carry chain.

In some embodiments, the critical path includes a path whose delay is the largest in the synthesis netlist.

In some embodiments, the reference path includes one or more look-up tables.

In some embodiments, the reference path includes a series of successive and adjacent look-up tables. The converting module 1030 is configured to convert each of the look-up tables in the reference path into the carry chain, in response to the number of actual inputs of the each of the look-up tables in the reference path being not greater than the preset threshold, and at least one of elements adjacent to the two ends of the reference path in the critical path being a carry chain.

In some embodiments, the path module 1020 is configured to perform, by using a static timing analysis tool, timing analysis on the synthesis netlist, and determine, through the timing analysis, the critical path in the synthesis netlist.

In some embodiments, the converting module 1030 is configured to replace the look-up table in the critical path with the carry chain, in such a manner that an actual signal input pin of the look-up table in the critical path is replaced with an input pin of the carry chain, and an actual signal output pin of the look-up table in the critical path is replaced with an output pin of the carry chain.

In some embodiments, the logic synthesis tool is Design Compiler.

It is notable that, the device embodiments are substantially similar to the method embodiments, so that the description of the device embodiments is relatively simple, and reference can be made to relevant description of the method embodiments. Any processing described in the method embodiments may be implemented by corresponding processing modules in the device embodiments, and details will not be repeated in the device embodiments.

Each module in the system for optimizing a circuit structure based on an FPGA carry chain may be implemented entirely or partially through software, hardware, or a combination thereof. The above modules may be embedded into or be independent of a processor in a computer device in a hardware form, or be stored in a memory of the computer device in a software form, so that the processor may invoke and execute the corresponding operations of the above modules.

FIG. 11 is a schematic structural diagram of a computer device according to some embodiments of the disclosure. The computer device may be a server, and an internal structure thereof may be as illustrated in FIG. 11. The computer device includes a processor, a memory, a network interface and a database that are connected via a system bus. The processor of the computer device is configured to provide computation and control ability. The memory of the computer device includes a computer storage medium and an internal memory. The storage medium stores an operating system, a computer program and a database therein. The internal memory provides an environment for the operating system and the computer program in the storage medium. The database of the computer device is configured to store data generated or acquired during the process of implementing the method for optimizing a circuit structure based on an FPGA carry chain. The network interface of the computer device is configured to communicate with an external terminal through a network connection. The computer program is executed by the processor to implement the method for optimizing a circuit structure based on an FPGA carry chain.

The embodiments of the disclosure provide a computer device. The computer device includes a memory, a processor, and a computer program stored in the memory and executable by the processor. The processor is configured to execute the computer program to implement operations of the method for optimizing a circuit structure based on an FPGA carry chain according to the above embodiments. Alternatively, the processor executes the computer program to execute the functions of the modules/units of the system for optimizing a circuit structure based on an FPGA carry chain, according to the above embodiments. To avoid repetition, details will not be repeated herein.

The embodiments of the disclosure provide a computer storage medium storing a computer program, i.e., a non-transitory computer-readable storage medium. The computer program, when being executed by the processor, causes operations of the method for optimizing a circuit structure based on an FPGA carry chain according to the above embodiments to be implemented. Alternatively, the processor executes the computer program to execute the functions of the modules/units of the system for optimizing a circuit structure based on an FPGA carry chain according to the above embodiments. To avoid repetition, details will not be repeated herein.

Those ordinarily skilled in the art may understand that all or some of procedures of the method in the above embodiments may be implemented by computer programs instructing relevant hardware. The computer programs may be stored in a non-volatile computer-readable storage medium. The computer programs, when being executed, may cause the procedures of the above method embodiments to be implemented. Any reference to the memory, the storage, the database, or other medium used in the embodiments provided in the disclosure may all include at least one of a non-volatile memory or a volatile memory. The non-volatile memory may include a read-only memory (ROM), programmable ROM (PROM), electrically programmable ROM (EPROM), electrically erasable programmable ROM (EEPROM), or flash memory. The volatile memory may be a random-access memory (RAM) or an external cache. As illustration rather than limitation, RAM may take various forms, such as a static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), rambus direct RAM (RDRAM), direct rambus dynamic RAM (DRDRAM), and memory bus dynamic RAM (RDRAM).

Those skilled in the art can clearly understand that, for the convenience and concise of description, the division of the foregoing functional units and modules is merely used for illustration. In practice, the above functions may be allocated to different functional units and modules as required, that is, the internal structure of the device may be divided into different functional units and modules to complete all or part of the functions described above.

The above embodiments are merely intended to illustrate but not to limit the technical solutions of the disclosure. Although the disclosure has been described in detail with reference to the foregoing embodiments, it can be understood that, those of ordinary skill in the art can modify the technical solutions described in the foregoing embodiments or make equivalent substitutions for some technical features therein. These modifications or substitutions do not drive the essence of the corresponding technical solutions away from the spirit and scope of the technical solutions of the embodiments of the disclosure, and the corresponding technical shall be included in the protection scope of the disclosure.

What is claimed is:

1. A method for optimizing a circuit structure based on an FPGA carry chain, comprising:
performing, by a logic synthesis tool, logic synthesis on a target logic operation, and obtaining, through the logic synthesis, a synthesis netlist;
obtaining a critical path in the synthesis netlist; and
in response to the number of actual inputs of a look-up table in the critical path being not greater than a preset threshold, and at least one of elements adjacent to two ends of a reference path in the critical path being a carry chain, converting the look-up table in the critical path into a carry chain, wherein the reference path comprises the look-up table, and only one look-up table or a plurality of adjacent look-up tables compose the reference path.

2. The method as claimed in claim 1, wherein the preset threshold is determined based on a target FPGA chip, and the target FPGA chip is configured to implement the target logic operation.

3. The method as claimed in claim 2, wherein the preset threshold is a theoretical number of inputs of a look-up table in the carry chain of the target FPGA chip plus the number of cin pins.

4. The method as claimed in claim 2, wherein the preset threshold is a theoretical number of inputs of a look-up table in the carry chain of the target FPGA chip plus one.

5. The method as claimed in claim 1, wherein there is one or more critical paths.

6. The method as claimed in claim 1, wherein there are a plurality of critical paths;
converting the look-up table in the critical path into the carry chain in response to the number of actual inputs of the look-up table in the critical path being not greater than the preset threshold, and at least one of the elements adjacent to two ends of the reference path in the critical path being the carry chain, comprises:
for each of the plurality of critical paths,
calculating, in response to determining that there is a look-up table in the critical path, the number of actual input signals for the look-up table; and
in response to the number of the actual input signals being not greater than the preset threshold, and at least one of elements adjacent to two ends of a reference path where the look-up table is located being the carry chain, converting the look-up table in the critical path into the carry chain.

7. The method as claimed in claim 1, wherein the critical path comprises a path whose delay is the largest in the synthesis netlist.

8. The method as claimed in claim 1, wherein when the reference path comprises the plurality of adjacent look-up tables, converting the look-up table in the critical path into the carry chain in response to the number of actual inputs of the look-up table in the critical path being not greater than the preset threshold, and at least one of the elements adjacent to two ends of the reference path in the critical path being the carry chain, comprises:
in response to the number of actual inputs of each of the look-up tables in the reference path being not greater than the preset threshold, and at least one of the elements adjacent to the two ends of the reference path in the critical path being the carry chain, converting all the look-up tables in the critical path into respective carry chains.

9. The method as claimed in claim 1, wherein obtaining the critical path in the synthesis netlist, comprises:
performing, by using a static timing analysis tool, timing analysis on the synthesis netlist, and determining, through the timing analysis, the critical path in the synthesis netlist.

10. The method as claimed in claim 1, wherein converting the look-up table in the critical path into the carry chain, comprises:
replacing the look-up table in the critical path with the carry chain, in such a manner that an actual signal input pin of the look-up table in the critical path is replaced with an input pin of the carry chain, and an actual signal output pin of the look-up table in the critical path is replaced with an output pin of the carry chain.

11. The method as claimed in claim 1, wherein the logic synthesis tool is Design Compiler.

12. A computer device, comprising a memory, a processor, and a computer program stored in the memory and executable by the processor, wherein the processor is configured to execute the computer program to implement operations of a method for optimizing a circuit structure based on an FPGA carry chain, and the method comprises:
performing, by a logic synthesis tool, logic synthesis on a target logic operation, and obtaining, through the logic synthesis, a synthesis netlist;
obtaining a critical path in the synthesis netlist;
determining a reference path in the critical path, wherein the reference path is composed of only one look-up table or a plurality of adjacent look-up tables, and the number of actual inputs of each look-up table of the reference path is greater than a preset threshold; and
in response to at least one of elements adjacent to two ends of the reference path being a carry chain, converting the look-up table in the reference path into a carry chain.

13. The computer device as claimed in claim 12, wherein the preset threshold is determined based on a target FPGA chip, and the target FPGA chip is configured to implement the target logic operation.

14. The computer device as claimed in claim 12, wherein the preset threshold is a theoretical number of inputs of a look-up table in the carry chain of the target FPGA chip plus the number of cin pins.

15. The computer device as claimed in claim 12, wherein there are a plurality of critical paths; and
wherein determining the reference path in the critical path comprises:
for each of the plurality of critical paths,
calculating, in response to determining that there is a look-up table in the critical path, the number of actual input signals for the look-up table; and
determining, in response to the number of the actual input signals being not greater than the preset threshold, the reference path comprising the look-up table; and
wherein converting the look-up table in the reference path into the carry chain in response to at least one of elements adjacent to two ends of the reference path in the critical path being the carry chain, comprises:
for each of the plurality of critical paths,
converting, in response to at least one of elements adjacent to two ends of the reference path in the critical path being the carry chain, the look-up table in the reference path into the carry chain.

16. The computer device as claimed in claim 12, wherein when the reference path is composed by the plurality of adjacent look-up tables, converting the look-up table in the reference path into the carry chain comprises:
converting each of the plurality of the look-up tables in the reference path into a corresponding carry chain.

17. The computer device as claimed in claim 12, wherein obtaining the critical path in the synthesis netlist, comprises:
performing, by using a static timing analysis tool, timing analysis on the synthesis netlist, and determining, based on the timing analysis, a path whose delay is the largest in the synthesis netlist as the critical path.

18. The computer device as claimed in claim 12, wherein converting the look-up table in the reference path into the carry chain comprises:
replacing the look-up table in the reference path with the carry chain, in such a manner that an actual signal input pin of the look-up table in the reference path is replaced with an input pin of the carry chain, and an actual signal output pin of the look-up table in the reference path is replaced with an output pin of the carry chain.

19. A non-transitory computer-readable storage medium storing a computer program, wherein the computer program, when being executed by a processor, causes operations of a method for optimizing a circuit structure based on an FPGA carry chain, and the method comprises:
performing, by a logic synthesis tool, logic synthesis on a target logic operation, and obtaining, through the logic synthesis, a synthesis netlist;
obtaining a critical path in the synthesis netlist;
determining a reference path in the critical path, the reference path being composed of one look-up table or a plurality of adjacent look-up tables; and
in response to the number of actual inputs of each look-up table in the reference path being not greater than a preset threshold, and at least one of elements adjacent to two ends of the reference path being a carry chain, converting each look-up table in the reference path into a carry chain.

20. The non-transitory computer-readable storage medium as claimed in claim 19, wherein the preset threshold is determined based on a target FPGA chip, and the target FPGA chip is configured to implement the target logic operation.
